(19) United States
(12) Patent Application Publication
(10) Pub. No.: US 2012/0031282 A1
(43) Pub. Date: Feb. 9, 2012

(54) COOKING DEVICE

(76) Inventors: Hiroki Kitayama, Osaka (JP); Masahiro Nishijima, Osaka (JP)

(21) Appl. No.: 13/258,067

(22) PCT Filed: Apr. 16, 2010
(86) PCT No.: PCT/JP2010/056813

§ 371 Date: Sep. 21, 2011

(30) Foreign Application Priority Data
Apr. 16, 2009 (JP) 2009-100194

(51) Int. Cl. A47J 27/00

(52) U.S. Cl. 99/337

(57) ABSTRACT

A cooking device has a cam mechanism (104) which moves in association with the pivoting of a door (103). The cam mechanism (104) includes a cam roller (131) rotatably mounted to a support base (130), an arm (132) having a front end pivotable connected to the door (103), having a cam surface (134) in sliding contact with the cam roller (131), and capable of moving in to-and-fro direction relative to a casing, and a coiled spring (133) stretched between the support base (130) and a rear end of the arm (132). The arm (132) has a recess (135) on a surface facing the door (103). When the door (103) is fully open, the recess (135) forms between the door (103) and the arm (132) a space (S) having sufficient size allowing a user's finger to be inserted in and removed from the space.

### TECHNICAL FIELD

The present invention relates to a cooking device.

### BACKGROUND ART

There is a conventional cooking device disclosed in JP 2007-327677 A (PTL 1). As shown in FIG. 15, the cooking device includes a casing 501, a door 503 that is pivotably mounted on a front side of the casing 501, and a cam mechanism 504 that operates with pivotal movement of the door 103.

The cam mechanism 504 has a cam roller 531 and an arm 532 that is supported by the cam roller 531 so as to be movable in a to-and-fro direction with respect to the casing 501 (not shown in FIG. 15). A front end part of the arm 532 is pivotably connected to the door 503. On the other hand, a rear end part of the arm 532 is connected to the casing 501 through a coiled spring 533.

As the door 503 fully closed is made to pivot in an opening direction in the cooking device having the above configuration, the arm 532 moves in a frontward direction with respect to the casing 501 so that a portion of the arm 532 is protruded forward from the casing 501, as shown by two-dot chain lines in FIG. 15. As the door 503 fully opened is made to pivot in a closing direction, the arm 532 moves in a rearward direction with respect to the casing 501 so as to reach a state shown in solid lines in FIG. 15.

When the door 503 is fully opened in the conventional cooking device, as shown by the two-dot chain lines in FIG. 15, a space (a hatched part) that is generally shaped like a triangle in side view is produced between the protruded portion of the arm 532 and the door 503. The space is comparatively small when the door 503 is fully opened and is comparatively large when the door 503 is partly opened. That is, the space gradually becomes smaller with transition of the door 503 from a partly opened state to a fully opened state. In case that a user accidentally puts his/her fingers into the space when the door 503 is partly opened and then fully opens the door 503, accordingly, the fingers are nipped between the protruded portion of the arm 532 and the door 503.

For the conventional cooking device, therefore, there is a risk that a user may be injured when opening or closing the door 503.

It should be noted that FIG. 15 is presented for convenience for clarifying problems with the conventional cooking device and does not completely coincide with a figure disclosed in JP 2007-327677 A.

### CITATION LIST

### Patent Literature

PTL1: JP 2007-327677 A

### SUMMARY OF INVENTION

### Technical Problem

An object of the invention is to provide a cooking device by which safety in opening and closure of a door can be improved.

### Solution to Problem

A cooking device according to the present invention comprises:

a casing;

a heating compartment provided in the casing and having an opening on front face side thereof;

a door having one end pivotably mounted on the casing to open and close the opening of the heating compartment,

an arm having a front end part pivotably connected to the door, the arm being movable in a to-and-fro direction relative to the casing; and

a prevention mechanism preventing a finger or fingers of a user from being nipped when the door is opened and closed.

According to the cooking device having the above configuration, due to the provision of the prevention mechanism preventing a finger or fingers of a user from being nipped when the door is opened and closed, accidents can be prevented such as fracture of the fingers of the user that might be nipped between the door and the arm when the door is fully opened, so that safety in opening and closure of the door can be improved.

In one embodiment, when the door is fully opened, the prevention mechanism forms between the door and the arm a space of sufficient size allowing a finger or fingers of the user to be inserted in and withdrawn from the space.

According to the cooking device of the embodiment, when the door is fully opened, a space of sufficient size allowing a finger or fingers of the user to be inserted in and withdrawn from the space is formed between the door and the arm by the prevention mechanism. Thus the finger or fingers of the user can reliably be withdrawn, or removed, from the space even if the door is fully opened after the finger or fingers are inserted into the space between the door and the arm at a moment in partial opening of the door, for instance.

In one embodiment, the arm is movable by a cam mechanism.

According to the cooking device of the embodiment, because the arm is moved by the cam mechanism, an area in which the arm moves can be made small. Accordingly, a risk that the arm may be brought into contact with a hand of a user and/or the like can be reduced and safety of the user can be improved.

In one embodiment, the cam mechanism includes the arm, a cam roller rotatably mounted on a support part, and a spring member stretched between the casing and a rear end part of the arm. And, the arm includes a cam surface that is in slide contact with the cam roller, and a recess on a side of the arm that confronts the door such that the space of sufficient size allowing a finger or fingers of the user to be inserted in and withdrawn from the space is formed between the door and the arm by the recess when the door is fully opened.

According to the cooking device of the embodiment, because the space of sufficient size allowing a finger or fingers of the user to be inserted in and withdrawn from the space is formed between the door and the arm by the recess when the door is fully opened, safety of the user can reliably be improved with use of a simple structure.

In one embodiment, the prevention mechanism comprises the arm, which assumes a shape of a generally inverted letter U in side view once the door passes into a fully opened state from a fully closed state by 90° pivotal movement thereof, and the cooking device further comprises a spring member that biases the arm in a closing direction at beginning of opening of the door.

According to the cooking device of the embodiment, because the prevention mechanism comprises the arm that assumes the shape of a generally inverted letter U in side view once the door passes into the fully opened state from the fully closed state by 90° pivotal movement thereof, the space having the sufficient size allowing the finger(s) of the user to be inserted in and withdrawn from the space can reliably be formed between the door and the arm.

Besides, due to the provision of the spring member that biases the arm in the closing direction at beginning of opening of the door, the user can be prevented from being injured by the door being opened with great momentum when the door is opened.

In one embodiment, once the door passes into the fully opened state from the fully closed state by the 90° pivotal movement thereof, a distance between an end surface of the arm that confronts the door (referred to also as a door-side end surface) and a surface of the door that confronts the arm (referred to also as a arm-side surface) is not less than 10 mm and not more than 50 mm.

According to the cooking device of the embodiment, because once the door passes into the fully opened state from the fully closed state by the 90° pivotal movement thereof, there is a distance of not less than 10 mm between the door-side end surface of the arm and the arm-side surface of the door, a risk can be made extremely slight that fingers of the user could not be withdrawn from between the door and the arm with the fingers nipped between the door and the arm.

Besides, because once the door passes into the fully opened state from the fully closed state by the 90° pivotal movement thereof, there is a distance of not more than 50 mm between the door-side end surface of the arm and the arm-side surface of the door, the arm is prevented from being obstructive when an object to be cooked is put into or taken out of the heating compartment.

In one embodiment, the prevention mechanism comprises a prevention member that prevents the finger or fingers of the user from being nipped during transition of the door from the fully closed state to the fully opened state.

According to the cooking device of the embodiment, because the prevention mechanism comprises the prevention member that prevents the finger or fingers of the user from being nipped during transition of the door from the fully closed state to the fully opened state, any finger of the user is prevented from being nipped when the door is partly opened, for instance, and hence when the door is fully opened.

In one embodiment, the prevention member is a generally fan-shaped plate member mounted on an end part of the door on a side of the one end.

According to the cooking device of the embodiment, because the prevention member is a generally fan-shaped plate member mounted on an end part of the door on a side of the one end, safety of the user can reliably be improved with use of a simple structure.

In one embodiment, the prevention member is the arm, which assumes a shape of a generally letter V in side view once the door passes into the fully opened state from the fully closed state by 90° pivotal movement thereof.

According to the cooking device of the embodiment, because the arm, which is the prevention member, assumes the shape of a generally letter V in side view once the door passes into the fully opened state from the fully closed state by 90° pivotal movement thereof, it is possible to avoid formation of a space having a sufficient size allowing fingers of the user to be inserted in, during transition of the door from the fully closed state to the fully opened state.

### Advantageous Effects of Invention

According to the cooking device of the present invention, due to the provision of the prevention mechanism preventing a finger or fingers of a user from being nipped when the door is opened and closed, those accidents that otherwise might occur during the opening and closing of the door are prevented, and safety of the user is thus improved.

### BRIEF DESCRIPTION OF DRAWINGS

FIG. 1 is a schematic front view of a cooking device in accordance with a first embodiment of the invention;

FIG. 2 is a schematic section of the cooking device in accordance with the first embodiment;

FIG. 3 is a schematic side view of a door fully closed and a cam mechanism in the first embodiment;

FIG. 4 is a schematic side view of the door fully opened and the cam mechanism in the first embodiment;

FIG. 5 is a schematic side view of the door partly opened and the cam mechanism in the first embodiment;

FIG. 6 is a schematic side view of a lower front part of a cooking device in accordance with a second embodiment of the invention;

FIG. 7 is a schematic side view of the lower front part of the cooking device in accordance with the second embodiment of the invention;

FIG. 8 is a schematic side view of the lower front part of the cooking device in accordance with the second embodiment of the invention;

FIG. 9 is a schematic side view of a lower front part of a cooking device in accordance with a third embodiment of the invention;

FIG. 10 is a schematic side view of the lower front part of the cooking device in accordance with the third embodiment of the invention;

FIG. 11 is a schematic side view of the lower front part of the cooking device in accordance with the third embodiment of the invention;

FIG. 12 is a schematic side view of a lower front part of a cooking device in accordance with a fourth embodiment of the invention;

FIG. 13 is a schematic side view of the lower front part of the cooking device in accordance with the fourth embodiment of the invention;

FIG. 14 is a schematic side view of the lower front part of the cooking device in accordance with the fourth embodiment of the invention; and

FIG. 15 is a schematic diagram for illustrating a conventional cooking device.

### DESCRIPTION OF EMBODIMENTS

Hereinbelow, embodiments of the cooking device of the invention will be described in detail with reference to the drawings.

### First Embodiment

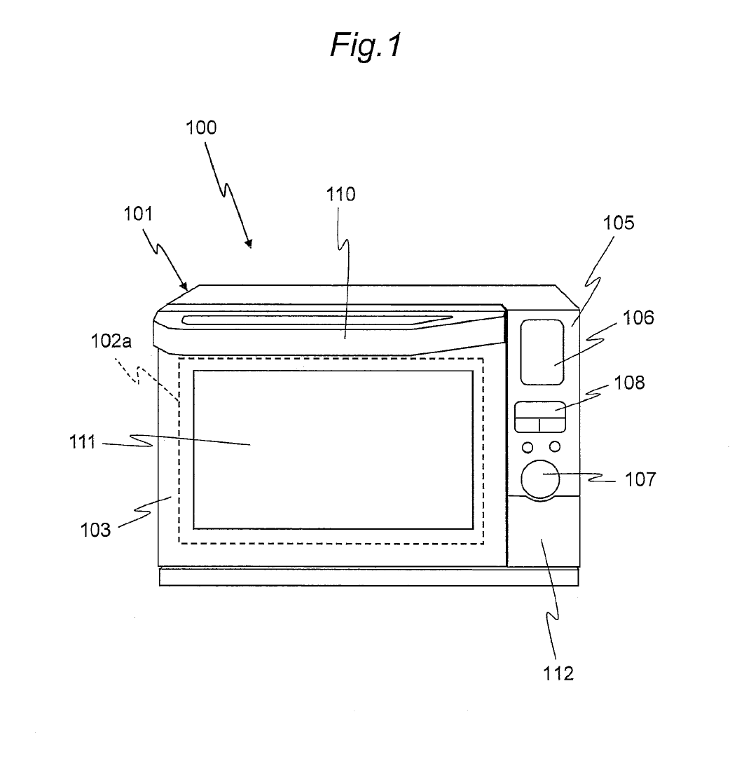

FIG. 1 is a schematic illustration of a cooking device 100 in accordance with a first embodiment of the invention as seen looking from a front face side thereof.

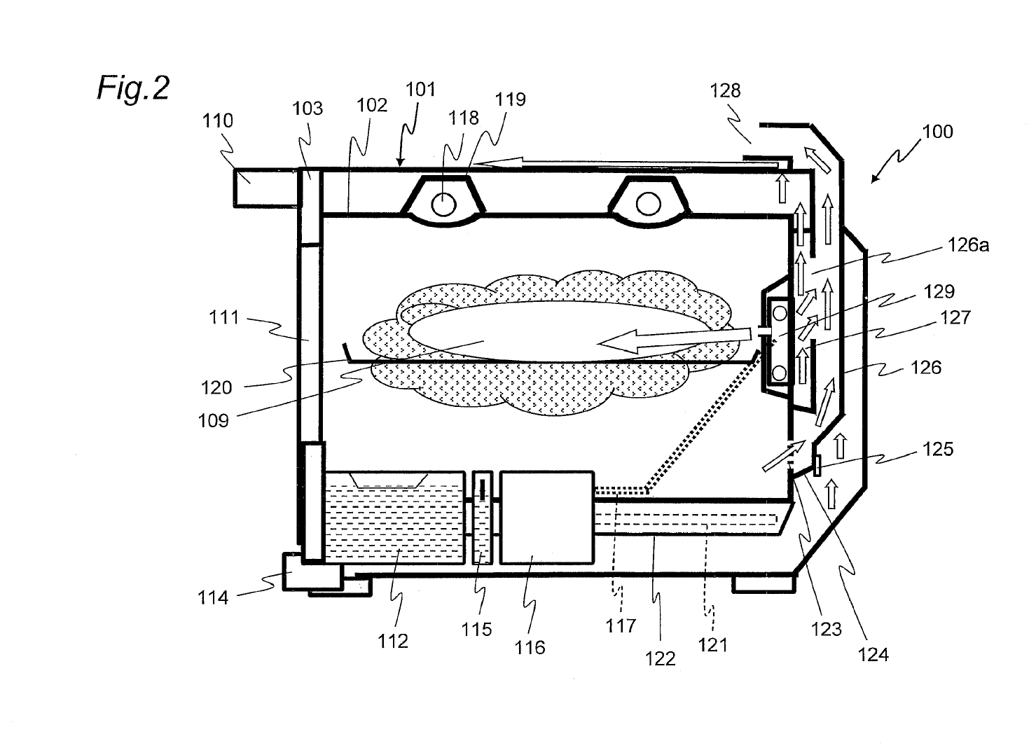

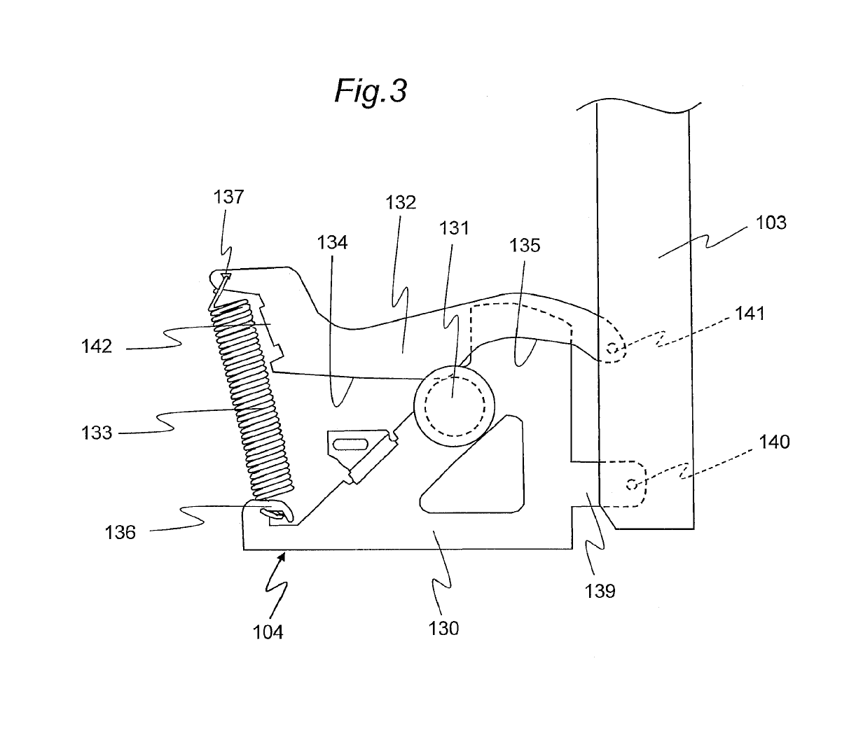

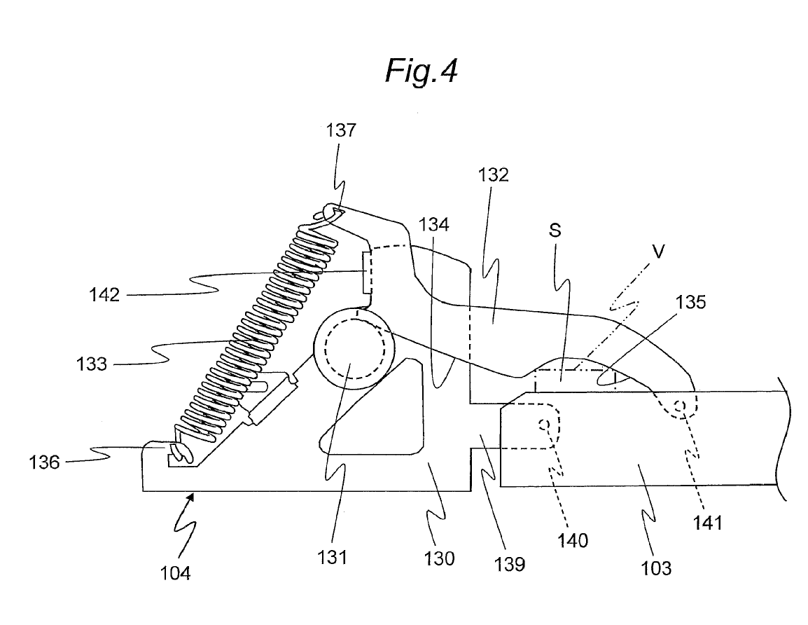

The cooking device 100 includes a casing 101 that is shaped like a rectangular parallelepiped, a heating compartment 102 (see FIG. 2) that is provided in the casing 101, a door 103 that is pivotably mounted in front of the casing 101, and a cam mechanism 104 (see FIGS. 3 and 4) that operates with pivotal movement of the door 103.

An opening 102a on front face side of the heating compartment 102 is opened and closed by the pivotal movement of the door 103. A handle 110 is mounted on an upper part of the door 103. Heat-resistant glass 111 is provided generally at a center part of the door 103, so that a user can observe a state of inside of the heating compartment 102 through the heat-resistant glass 111. Onto a rear face of the door 103, packing 112 (not shown) made of heat-resistant resin is fixed so as to surround the heat-resistant glass 111.

The packing is strongly pressed against a part surrounding the opening 102a of the heating compartment 102 when the door 103 is fully closed. Thus steam and/or the like in the heating compartment 102 are prevented from leaking out from between the door 103 and the part surrounding the opening 102a of the heating compartment 102.

An operation panel 105 is provided on a right side of a front face of the casing 101. The operation panel 105 has a liquid crystal display part 106, a dial 107, and a plurality of buttons 108. A front face of a water supply tank 112 is exposed under the dial 107. The water supply tank 112 is attachable to and detachable from the casing 101.

FIG. 2 is a schematic section of the cooking device 100, wherein reference numeral 114 denotes a drip tray, numeral 115 denotes a water level sensor, numeral 116 denotes a water supply pump, numeral 117 denotes a water supply pipe, numeral 118 denotes an upper heater, numeral 119 denotes an upper heater cover, numeral 120 denotes a tray, numeral 121 denotes a lower heater, numeral 122 denotes a thermal insulation plate, numeral 123 denotes an exhaust port, numeral 124 denotes an exhaust port cover, numeral 125 denotes an exhaust thermo-sensor, numeral 126 denotes an exhaust duct, numeral 126a denotes a cool-air introducing opening, numeral 127 denotes a cool-air path, numeral 128 denotes a diluted-exhaust port, and numeral 129 denotes a steam producing unit. Though not shown, a magnetron for producing microwave is also provided in the casing 101.

The water supply pump 116 sucks water from the water supply tank 112 and delivers the water through the water supply pipe 117 to the steam producing unit 129. The steam producing unit 129 is capable of producing steam by heating the water from the water supply pump 116 and supplying the steam into the heating chamber 102 and also capable of producing superheated steam by heating the steam and supplying the superheated steam into the heating chamber 102. Herein, the above-mentioned superheated steam refers to steam heated to a superheated state with temperatures of higher than 100° C.

An object to be cooked 109 can be heated by the steam or the superheated steam from the steam producing unit 129 and/or can be heated by radiant heat from the upper heater 118 and the lower heater 121. A top wall of the heating compartment 102 is under the upper heater 118 and a bottom wall of the heating compartment 102 is above the lower heater 121, so that the upper heater 118 and the lower heater 121 are not exposed in the heating compartment 102.

FIG. 3 is a schematic illustration of the door 103 fully closed and the cam mechanism 104 as seen looking from a lateral side. FIG. 4 is a schematic illustration of the door 103 fully opened and the cam mechanism 104 as seen looking from the lateral side.

As shown in FIGS. 3 and 4, the cam mechanism 104 has a support base 130, a cam roller 131, an arm 132, and a coiled spring 133. Though only the cam mechanism 104 on the left side (which is a side opposite to the operation panel 105) of the heating compartment 102 is shown in FIGS. 3 and 4, a cam mechanism similar to or same as the cam mechanism 104 is provided on the right side (which is a side including the operation panel 105) of the heating compartment 102 as well. The support base 130 is an example of a support part, and the coiled spring 133 is an example of a spring member.

The support base 130 is fixed to a bottom part of the casing 101. The support base 130 has an edge that extends in a horizontal direction, an edge that extends in a vertical direction, and an edge that extends so as to be inclined with respect to the horizontal direction, and is generally shaped like a right triangle in side view. The support base 130 has a hinge part 139 extending from the edge that extends in the vertical direction. A lower end part of the door 103 is pivotably mounted on the hinge part 139 through a door mounting shaft 140. The door mounting shaft 140 is positioned below an arm connecting shaft 141 when the door 103 is fully closed and is positioned to rear of the arm connecting shaft 141 when the door 103 is fully opened. The arm connecting shaft 141 is provided inside the door 103 so as not to be exposed.

The cam roller 131 is rotatably mounted on the edge of the support base 130 that extends so as to be inclined with respect to the horizontal direction, and supports the arm 132 in such a manner that the arm 132 is movable in a to-and-fro direction.

A front end part of the arm 132 is connected to the door 103 through the arm connecting shaft 141, so that the arm 132 is pivotable on the arm connecting shaft 141 with respect to the door 103. The arm 132 has a cam surface 134 and a recess 135 on a face thereof confronting the cam roller 131 and has an engagement part 142 on a face thereof confronting the coiled spring 133.

The cam surface 134 is in slide contact with the cam roller 131. Sliding of the cam surface 134 on the cam roller 131 makes it possible for the arm 132 to follow the pivotal movement of the door 103.

A section of the engagement part 142 that is taken along a horizontal plane is generally shaped like a letter U, so that the engagement part 142 nips and engages with the edge of the support base 130 when the door 103 is fully opened. Thus forward movement of the arm 132 relative to the casing 101 is restricted. When the door 103 is fully opened, clockwise moment about the door mounting shaft 140 is caused on the door 103 by gravity and counterclockwise moment about a contact point between the arm 132 and the cam roller 131 is caused on the arm 132 by a tension of the coiled spring 133. The former moment is greater than the latter moment and thus the door 103 is kept open when a user takes his/her hand off the handle 110. As the user makes the door 103 pivot from its full open position in a closing direction, the engagement part 142 is released from engagement and the arm 132 moves rearward by receiving a biasing force from the coiled spring 133 and a force from the user.

The recess 135 is provided on the side of the arm 132 that confronts the door 103 and is composed of a curved surface extending from a front end of the cam surface 134. The recess 135 has such a shape as to form a space S, having a sufficient size allowing fingers of the user to be inserted therein and withdrawn therefrom, between the door 103 and the arm 132 when the door 103 is fully opened. More specifically, the shape of the arm 132 is designed so that a rectangle V shown by two-dot chain lines in FIG. 4 has a height within a range of, e.g., from 15 to 20 mm and a width within a range of, e.g., from 20 to 30 mm. The rectangle V, which is a virtual figure, has a side coincident with an arm 132-side edge of the door 103, and two corners in contact with the recess 135 of the arm.

One end of the coiled spring 133 is hooked on a bend part 136, generally shaped like a hook, of a rear end part of the support base 130. The other end of the coiled spring 133 is inserted in a through hole 137 in a rear end part of the arm 132. That is, the coiled spring 133 is stretched between the rear end part of the support base 130 and the rear end part of the arm 132. The coiled spring 133 strongly biases the door 103 against the casing 101 through the arm 132. Thus the packing is strongly pressed against the part surrounding the opening 102a of the heating compartment 102 when the door 103 is fully closed.

When the door 103 is made to pivot for transition thereof from a fully closed state in FIG. 3 to a fully opened state in FIG. 4, in the cooking device 100 having the above configuration, the cam surface 134 slides on the cam roller 131 and the arm 132 moves forward so as to follow the pivotal movement of the door 103. When the door 103 is fully opened, the recess 135 on the arm 132 forms the space S, having the sufficient size allowing a finger or fingers of the user to be inserted therein and withdrawn therefrom, between the door 103 and the arm 132.

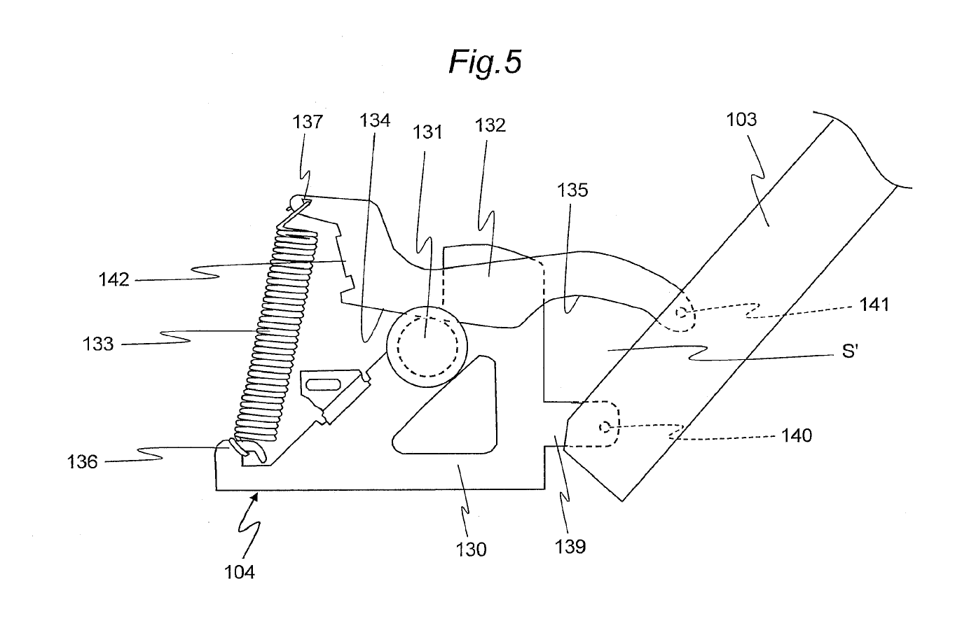

A space S′ having a sufficient size allowing fingers of the user to be inserted therein and withdrawn therefrom is formed between the door 103 and the arm 132 when the door 103 is partly opened, for instance, as shown in FIG. 5, and the door 103 and the arm 132 can be prevented from strongly nipping fingers of the user even if the door 103 is fully opened with the fingers of the user inserted in the space S′.

As a result, occurrence of accidents can be prevented such as fracture of a finger of the user which might otherwise be caused by the nip of the finger between the door 103 and the arm 132 when the door 103 is fully opened. That is, safety of the user can be improved in opening and closure of the door 103.

The cam mechanism 104 has the coiled spring 133 stretched between the rear end part of the support base 130 and the rear end part of the arm 132 in the first embodiment, whereas the cam mechanism 104 may have a coiled spring stretched between the casing 101 and the rear end part of the arm 132.

That is, in the invention, one end of the spring member may be mounted on the casing or may be mounted on another member fixed to the casing.

Though the hinge part 139 is provided on the support base 130 in the first embodiment, the hinge part 139 may be provided on the casing 101.

Though the cam roller 131 is rotatably mounted on the support base 130 in the first embodiment, the cam roller 131 may rotatably be mounted on the casing 101, for instance.

That is, the cam roller in the invention may rotatably be mounted on the casing or may rotatably be mounted on another member fixed to the casing.

The cooking device includes the cam mechanism 104 having the support base 130, the cam roller 131, the arm 132 and the coiled spring 133 in the first embodiment, whereas the cooking device may include a cam mechanism composed of members other than the support base 130, the cam roller 131, the arm 132 and the coiled spring 133.

### Second Embodiment

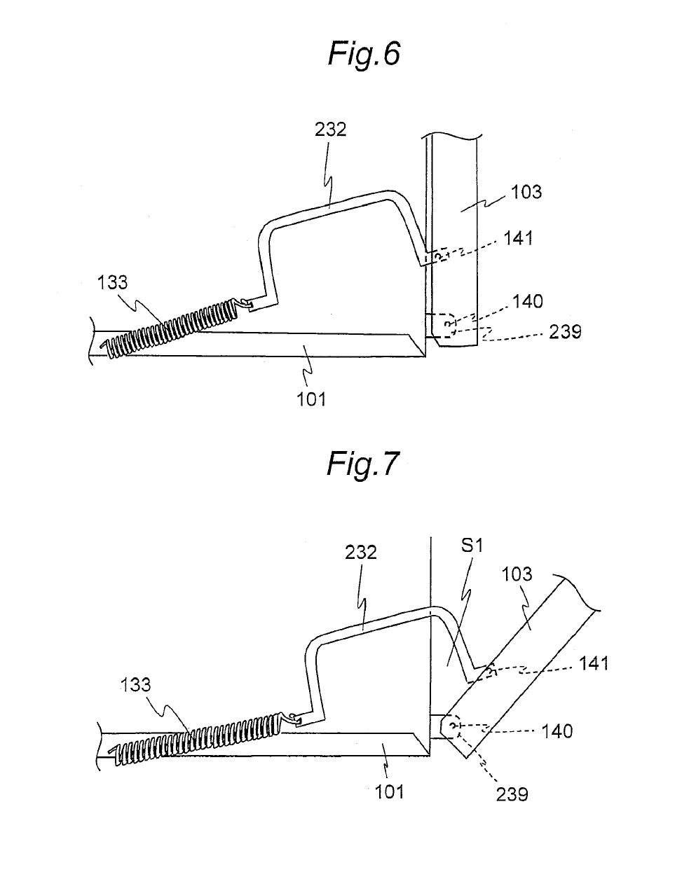

FIGS. 6 through 8 are schematic illustrations of lower front part of a cooking device in accordance with a second embodiment of the invention as seen looking from a lateral side thereof. In FIGS. 6 through 8, the same components as those of the first embodiment are provided with the same reference numerals as those in the first embodiment, and description thereof is omitted. In description below, the same components as those of the first embodiment are provided with the same reference numerals as those in the first embodiment, and description thereof will be omitted.

As shown in FIG. 6, the cooking device includes an arm 232 of which a front end part is pivotably connected to the door 103 and which is movable in a to-and-fro direction relative to the casing 101, but has no cam mechanism. Though the arm 232 is provided on the left side (which is a side opposite to the operation panel 105) of the heating compartment 102, an arm (not shown) similar to the arm 232 is provided also on the right side (which is a side including the operation panel 105) of the heating compartment 102. The arm 232 is an example of the prevention mechanism.

A lower end part of the door 103 is mounted through a hinge 239 on lower front side of the casing 101. In FIGS. 6 through 8, it is omitted to show a side part of the casing 101.

A front end part of the arm 232 is connected to the door 103 through the arm connecting shaft 141, so that the arm 232 is pivotable on the arm connecting shaft 141 with respect to the door 103. One end of the coiled spring 133 is connected to a rear end part of the arm 232. The other end of the coiled spring 133 is connected to a specified site on the casing 101.

The coiled spring 133 biases the arm 232 in a closing direction at beginning of opening of the door 103. More specifically, by the coiled spring 133, the door 103 is biased toward the casing 101 when the door 103 is fully closed and a downward force is exerted on the arm connecting shaft 141 when the door 103 is fully opened.

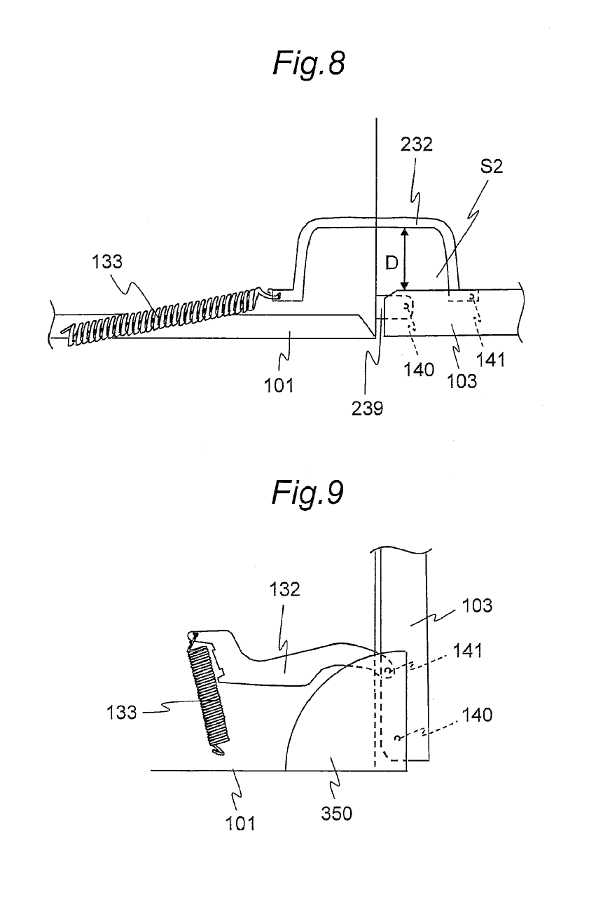

A space S1 having a sufficient size allowing a finger or fingers of a user to be inserted therein and withdrawn therefrom is formed between the door 103 and the arm 232 when the door 103 is partly opened as shown in FIG. 7, for instance, in middle of transition of the door 103 from a fully closed state in FIG. 6 to a fully opened state in FIG. 8 by 90° pivotal movement thereof.

Also, when the door 103 passes into the fully opened state in FIG. 8, a space S2 having a sufficient size allowing a finger or fingers of the user to be inserted therein and withdrawn therefrom is formed between the door 103 and the arm 232. At that time, the arm 232 has a shape of a generally inverted letter U, and a distance D between a door-side end surface of the arm 232 (which is a surface that confronts the door 103) and an arm-side surface of the door 103 (which is a surface that confronts the arm 232) is not less than 10 mm and not more than 50 mm.

In the cooking device having the above configuration, the space S2 having the sufficient size allowing fingers of the user to be inserted therein and withdrawn therefrom is formed between the door 103 and the arm 232 when the door 103 is fully opened, and thus the fingers can reliably be withdrawn from between the door 103 and the arm 132 even if the door 103 is fully opened after the fingers of the user are inserted between the door 103 and the arm 232 when the door 103 is partly opened, for instance.

As a result, occurrence of accidents can be prevented such as fracture of the fingers of the user that might be nipped between the door 103 and the arm 132.

The arm 232 assumes the shape of a generally inverted letter U in side view once the door 103 passes into the fully opened state in FIG. 8 from the fully closed state in FIG. 6 by the 90° pivotal movement thereof, and thus the space S2 having the sufficient size allowing a finger or fingers of the user to be inserted therein and withdrawn therefrom can reliably be formed between the door 103 and the arm 232 when the door 103 is fully opened.

The distance D between the end surface of the arm 232 that faces the door 103 and the surface of the door 103 that faces the arm 232 is not less than 10 mm once the door 103 passes into the fully opened state in FIG. 8 from the fully closed state in FIG. 6 by the 90° pivotal movement thereof, and thus a risk can be made extremely slight that fingers of the user could not be withdrawn from between the door 103 and the arm 232 because being nipped between the door 103 and the arm 232.

The distance D between the end surface of the arm 232 that faces the door 103 and the surface of the door 103 that faces the arm 232 is not more than 50 mm once the door 103 passes into the fully opened state in FIG. 8 from the fully closed state in FIG. 6 by the 90° pivotal movement thereof, and thus the arm 232 can be prevented from being obstructive when the object to be cooked 109 is put into or taken out of the heating compartment 102.

### Third Embodiment

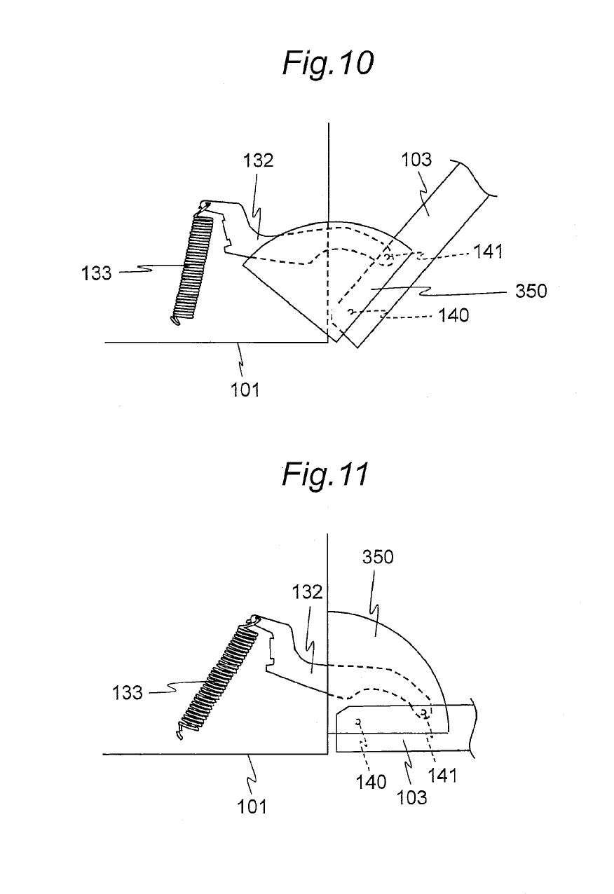

FIGS. 9 through 11 are schematic illustrations of lower front part of a cooking device in accordance with a third embodiment of the invention as seen looking from a lateral side thereof. In FIGS. 9 through 11, the same components as those of the first embodiment are provided with the same reference numerals as those in the first embodiment, and description thereof is omitted. In FIGS. 9 through 11, some components are not shown for the sake of facilitation of understanding. In the description below, the same components as those of the first embodiment are provided with the same reference numerals as those in the first embodiment, and description thereof will be omitted.

The cooking device of this embodiment is different from the cooking device of the first embodiment only in that the former includes a plate member 350 that is generally shaped like a fan or sector in side view. Though the plate member 350 is provided on the left side (which is a side opposite to the operation panel 105) of the heating compartment 102, a plate member (not shown) same as the plate member 350 is provided also on the right side (which is a side including the operation panel 105) of the heating compartment 102. In FIGS. 9 through 11, a lateral side part of the casing 101 is not shown. The plate member 350 is an example of the prevention member.

The plate member 350 is mounted on a lower end part of one lateral end face of the door 103 so that at least a portion of the arm 132 cannot be seen from the lateral side when the door 103 is opened and closed. Thus a space having a sufficient size allowing a finger or fingers of a user to be inserted therein is not formed between the door 103 and the arm 132 during transition of the door 103 from a fully closed state to a fully opened state.

In the cooking device having the above configuration, the generally fan-shaped plate member 350 is mounted on the lower end part of the door 103 and thus fingers of a user are prevented from being inserted into between the door 103 and the arm 132 when the door 103 is opened and closed.

As a result, the fingers of the user are prevented from being nipped between the door 103 and the arm when the door 103 is fully opened, so that safety in opening and closure of the door 103 can reliably be improved with use of a simple structure.

The third embodiment has the configuration in which the plate member 350 is added to the cooking device 100 of the first embodiment, whereas the plate member 350 may be added to cooking devices other than the first embodiment. For instance, the plate member 350 may be added to the cooking device of JP 2007-327677 A. Injury to a user can be prevented by the cooking device of JP 2007-327677 A to which the plate member 350 is added, for instance, as done by the third embodiment.

Modifications similar to those described for the first embodiment may be made to the third embodiment.

### Fourth Embodiment

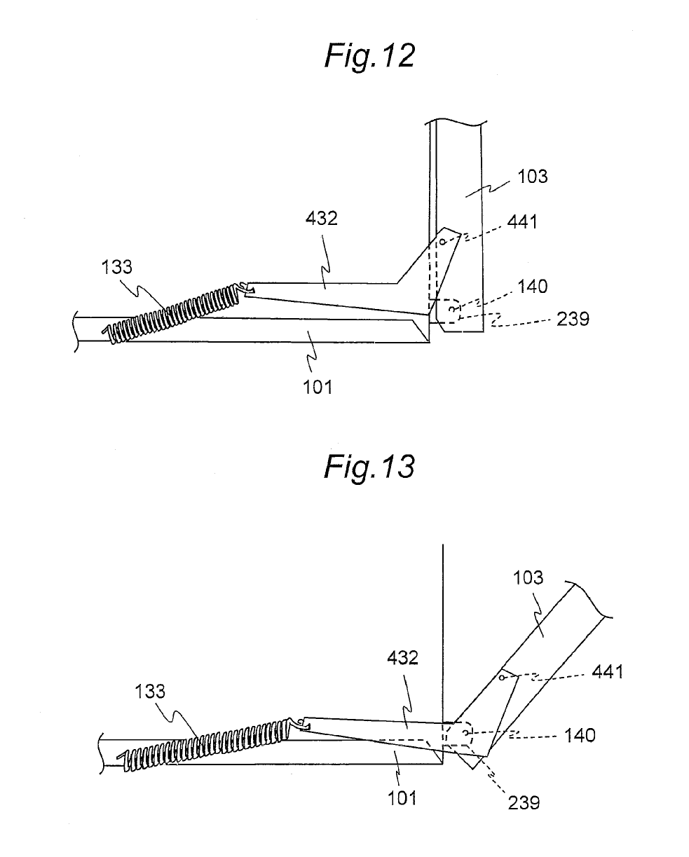

FIGS. 12 through 14 are schematic illustrations of a lower front part of a cooking device in accordance with a fourth embodiment of the invention as seen looking from a lateral side thereof. In FIGS. 12 through 14, the same components as those of the first embodiment are provided with the same reference numerals as those in the first embodiment, and description thereof is omitted. In the description below, the same components as those of the first embodiment are provided with the same reference numerals as those in the first embodiment, and description thereof will be omitted.

As shown in FIG. 12, the cooking device includes an arm 432 of which front end part is pivotably connected to the door 103 and which is movable in a to-and-fro direction relative to the casing 101, but has no cam mechanism. Though the arm 432 is provided on the left side (which is a side opposite to the operation panel 105) of the heating compartment 102, an arm (not shown) similar to the arm 432 is provided also on the right side (which is a side including the operation panel 105) of the heating compartment 102 as well. The arm 432 is an example of the prevention member.

A lower end part of the door 103 is mounted through the hinge 239 on a lower front side of the casing 101. In FIGS. 12 through 14, a lateral side part of the casing 101 is not shown.

The front end part of the arm 432 is connected to the door 103 through an arm connecting shaft 241 provided on one side end face of the door 103, so that the arm 432 is pivotable on the arm connecting shaft 441 with respect to the door 103. One end of the coiled spring 133 is fitted to a rear end part of the arm 432. The other end of the coiled spring 133 is fitted to a specified site of the casing 101.

The coiled spring 133 biases the arm 432 in a closing direction at beginning of opening of the door 103. By the coiled spring 133, more specifically, the door 103 is biased toward the casing 101 when the door 103 is fully closed and a downward force is exerted on the arm connecting shaft 441 when the door 103 is fully opened.

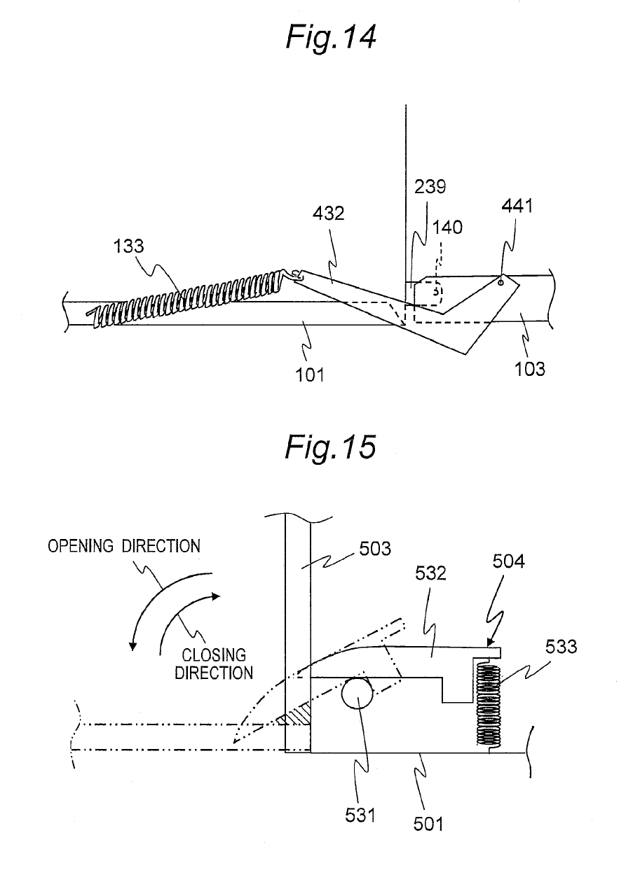

A space having a sufficient size allowing fingers of a user to be inserted therein and withdrawn therefrom is not formed between the door 103 and the arm 432 when the door 103 is partly opened as shown in FIG. 13, for instance, in middle of transition of the door 103 from a fully closed state in FIG. 12 to a fully opened state in FIG. 14 by 90° pivotal movement thereof.

A space having a sufficient size allowing the fingers of the user to be inserted therein and withdrawn therefrom is not formed between the door 103 and the arm 432 when the door 103 is in the fully opened state in FIG. 14. At that time, the arm 432 is generally in shape of a letter V in side view.

In the cooking device having the above configuration, which includes the arm 432, the space having the sufficient size allowing a finger or fingers of a user to be inserted therein and withdrawn therefrom is not formed between the door 103 and the arm 432 during the transition of the door 103 from the fully closed state in FIG. 12 to the fully opened state in FIG. 14 by the 90° pivotal movement thereof.

As a result, the fingers of the user are prevented from being nipped between the door 103 and the arm when the door 103 is fully opened, so that safety in opening and closure of the door 103 can reliably be improved.

That is, the cooking device of the fourth embodiment attains functional effects similar to those of the third embodiment. In the cooking device of the fourth embodiment, in addition, no cam mechanism is provided and thus number of components thereof and cost for manufacture thereof can be reduced in comparison with the third embodiment.

Though the steam producing unit 129 that has a function of producing superheated steam is mounted in the cooking device 100 in the first through fourth embodiments, a steam producing device that merely produces steam and that has no function of producing superheated steam may be mounted in the cooking device 100.

The invention may be applied not only to microwave ovens in which superheated steam is used but also to cooking devices such as cooking ovens, cooking ranges, microwave ovens, and IH cooking heaters in which superheated steam is not used and cooking devices such as cooking ovens, cooking ranges, and IH cooking heaters in which superheated steam is used, for instance.

With the cooking devices of the invention, healthy cooking can be performed by use of superheated steam or saturated steam in cooking heaters (including those using IH heaters, electric cooking stoves such as electric heaters, or gas cooking stoves), microwave ovens and the like. In the cooking devices of the invention, for instance, superheated steam or saturated steam having a temperature not lower than 100° C. is supplied onto surfaces of food, the superheated steam or saturated steam deposited onto the surfaces of the food condenses and gives the food a great quantity of latent heat of condensation, and therefore heat can efficiently be transmitted to the food. The condensate water is deposited on the surfaces of the food, and salt content, oil content and the like of the food drop with the condensate water, so that salt content, oil content and the like of the food can be reduced. Furthermore, the heating compartment is filled with the superheated steam or saturated steam so as to be in a state poor in oxygen, and thus cooking by which oxidation of the food is suppressed can be performed.

The invention is not limited to the first through fourth embodiments and can be embodied with modification in various ways within the scope of the invention. For instance, matters described for the first through fourth embodiments may be appropriately combined as needed and such combination may be implemented as an embodiment of the invention.

The invention can be applied not only to cooking devices having doors of vertical opening type as in the first through fourth embodiments but also to cooking devices having doors of horizontal opening type.

### REFERENCE SIGNS LIST

100 cooking device

101 casing

102 heating compartment

103 door

104 cam mechanism

130 support base

131 cam roller

132, 232, 432 arm

133 coiled spring

134 cam surface

135 recess

350 plate member

S, S′, S1, S2 space

1. A cooking device comprising:
a casing;
a heating compartment provided in the casing and having an opening on front face side thereof;
a door having one end pivotably mounted on the casing to open and close the opening of the heating compartment,
an arm having a front end part pivotably connected to the door, the arm being movable in a to-and-fro direction relative to the casing; and
a prevention mechanism preventing a finger or fingers of a user from being nipped when the door is opened and closed.

2. The cooking device as claimed in claim 1, wherein
when the door is fully opened, the prevention mechanism forms between the door and the arm a space of sufficient size allowing a finger or fingers of the user to be inserted in and withdrawn from the space.

3. The cooking device as claimed in claim 2, wherein
the arm is movable by a cam mechanism.

4. The cooking device as claimed in claim 3, wherein
the cam mechanism comprises:
the arm;
a cam roller rotatably mounted on a support part; and
a spring member stretched between the casing and a rear end part of the arm,
the arm including a cam surface that is in slide contact with the cam roller, and a recess on a side of the arm that confronts the door such that the space of sufficient size allowing a finger or fingers of the user to be inserted in and withdrawn from the space is formed between the door and the arm by the recess when the door is fully opened.

5. The cooking device as claimed in claim 2, wherein
the prevention mechanism comprises the arm, which assumes a shape of a generally inverted letter U in side view once the door passes into a fully opened state from a fully closed state by 90° pivotal movement thereof, and wherein
the cooking device further comprises a spring member that biases the arm in a closing direction at beginning of opening of the door.

6. The cooking device as claimed in claim 5, wherein
a distance between an end surface of the arm that confronts the door and a surface of the door that confronts the arm is not less than 10 mm and not more than 50 mm once the door passes into the fully opened state from the fully closed state by the 90° pivotal movement thereof.

7. The cooking device as claimed in claim 1, wherein
the prevention mechanism comprises a prevention member that prevents the finger or fingers of the user from being nipped during transition of the door from a fully closed state to a fully opened state.

8. The cooking device as claimed in claim 7, wherein
the prevention member is a generally fan-shaped plate member mounted on an end part of the door on a side of the one end.

9. The cooking device as claimed in claim 7, wherein
the prevention member is the arm, which assumes a shape of a generally letter V in side view once the door passes into the fully opened state from the fully closed state by 90° pivotal movement thereof.
